(19) United States
(12) Patent Application Publication
(10) Pub. No.: US 2009/0183535 A1
(43) Pub. Date: Jul. 23, 2009

(54) Unicycle lock

(76) Inventor: Kevin Joseph Darville, Fairfield, CA (US)

Correspondence Address: Kevin Joseph Darville, 2814 Rockville Road, Fairfield, CA, 94534, US

(21) Appl. No.: 12/009,699

(22) Filed: Jan. 22, 2008

(51) Int. Cl. E05B 67/06

(52) U.S. Cl. 70/18

(57) ABSTRACT

This invention relates to the field of locks, more specifically to locking up a unicycle. Currently there is not an effective way to lock up a unicycle. Many people do not lock up their unicycles, or they only lock them through the wheel. The wheel is one of the cheapest parts of the unicycle. The most expensive part, the unicycle frame, is not protected. Thieves simply remove the wheel, and take the unicycle frame. My embodiments prevent the theft of the unicycle wheel, and the unicycle frame. My embodiments are economical to produce, and easy to use. My embodiments let a unicycle rider lock up their unicycle anywhere, without concern for theft.

### CROSS-REFERENCED TO RELATED APPLICATIONS

Not Applicable

### FEDERALLY SPONSORED RESEARCH

Not Applicable

### SEQUENCE LISTING OR PROGRAM

Not Applicable

### BACKGROUND—FIELD OF INVENTION

This invention solves the problem of locking up a unicycle in a way where it cannot be easily stolen.

1. Field of Invention

This invention generally relates to unicycles and locks, specifically to a way to lock up a unicycle in an effective manner to deter or prevent theft.

2. Prior Art

Right now there is not an effective way to lock up most unicycles. Only a unicycle with a closed body, which is rare and expensive, can be locked up effectively.

Most unicyclists simply lock up the wheel, which can easily be removed. After the wheel is removed a thief can simply take the unicycle frame, leaving the wheel. Most unicyclists do not lock them up at all. Not locking up a unicycle is foolhardy. While you may assume that nobody would steal it, that assumption is wrong and can cost you quite a bit of money. A good unicycle cost many hundreds of dollars. Right now, there are no locks whatsoever capable of locking up a unicycle. While it may be assumed that there would be little use or demand for this product, I believe that is wrong. Ten thousand unicycles are sold from one website alone per year. These unicyclists are lacking a means to lock up their costly investment while on campus, at the beach, at grocery stores, or wherever they would like to ride.

### SUMMARY

In accordance with one embodiment my invention is a new unicycle locking device, which secures not only the unicycle wheel, but the unicycle frame as well to a fixed structure such as a railing.

### DRAWINGS—FIGURES

FIG. 1 Shows the first embodiment attached to a unicycle and fixed structure.

FIG. 2 Shows the first embodiment.

FIG. 3 Shows the first embodiment.

FIG. 4 Shows the second embodiment.

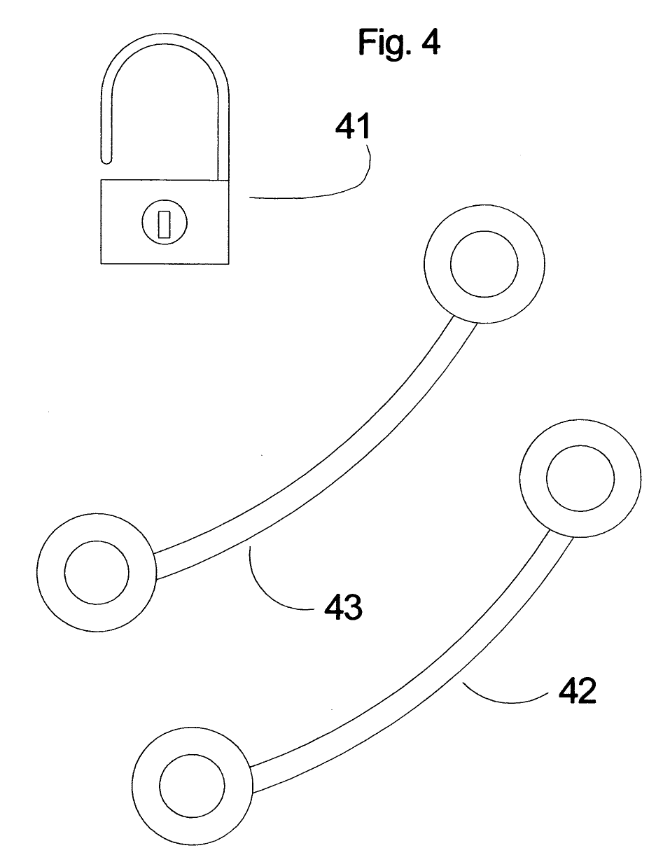

### DRAWINGS—REFERENCE NUMERALS

1 A typical unicycle
2 Unicycle lock
3 A fixed structure such as a bicycle rack
21 U lock portion of unicycle lock
22 Bottom cable
23 Top cable
24 Fixed loop of top cable
25 Fixed loop of bottom cable
41 U lock
42 Top cable with fixed loops on both ends
43 Bottom cable with fixed loops on both ends

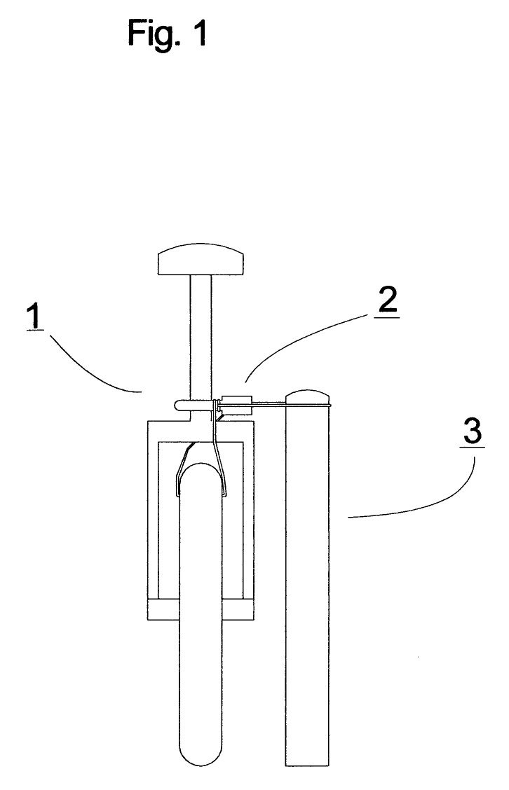

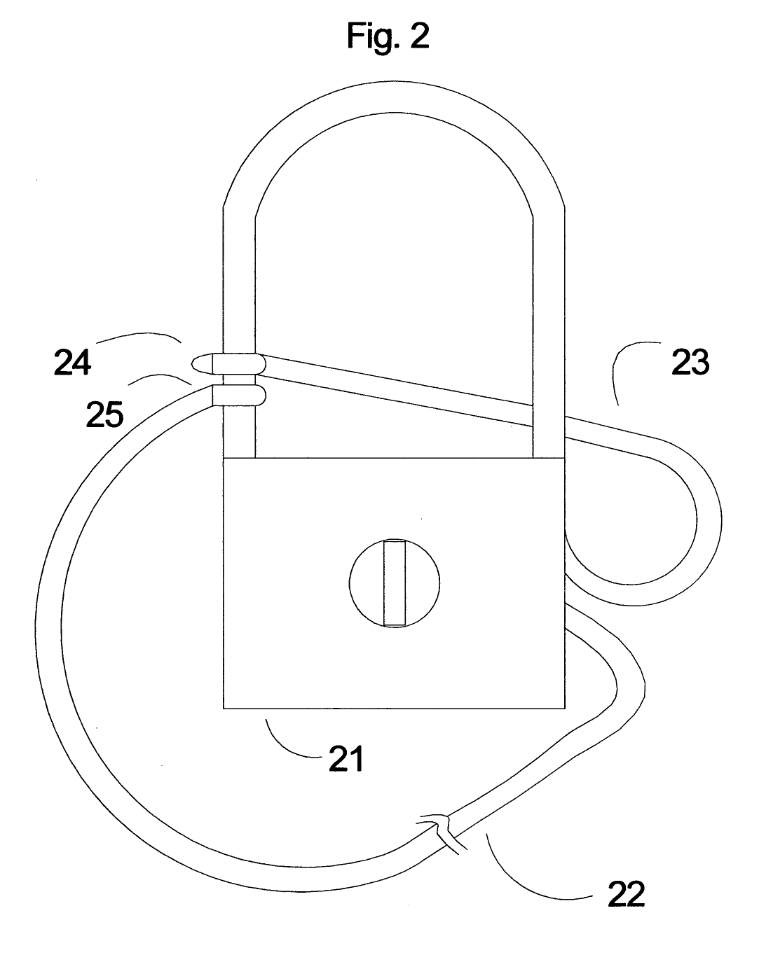

### DETAILED DESCRIPTION—FIGS. 1, 2,3 AND 4—PREFERRED EMBODIMENT

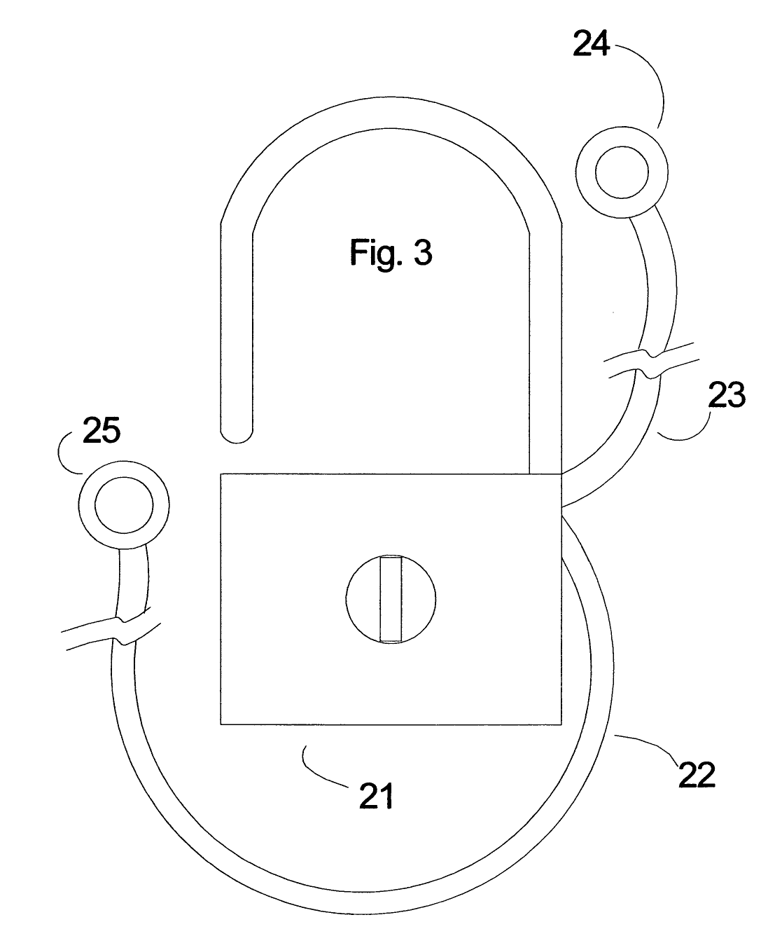

My preferred embodiment is shown in FIG. 1-3. My preferred embodiment consist of a U lock, padlock or other applicable type lock 21 which I contemplate could be made of steel or another durable material which locks are commonly made of and could be wrapped in abs, plastic, rubber, or similar materials to prevent scratching of the unicycle 1 paint. The top cable 23 and a bottom cable 22 fixed securely to the U lock 21. I contemplate the top cable 23 and the bottom cable 22 could be made of steel wrapped in a softer material such as plastic, such as it common on bicycle locks. The top cable 23 has a fixed loop 24 at the end of it, such that a thief may not open it. The bottom cable 22 has a fixed loop 25 secured at the end of it, such that a thief may not open it. The top loop 24, and the bottom loop 25 should be able to fit over the shackle portion of U lock 21.

### OPERATION—FIGS. 1, 2, AND 3

The operation of my preferred embodiment of the Unicycle lock is quite simple. All one has to do is put the U lock 21 on the frame of the unicycle in an open position. Then wrap the top cable 23 down, over the forks of the unicycle and through the tire. Position the top loop 24 so the loop is around the shackle of the U lock 21. Then take the bottom cable 22 and wrap it through a fixed structure, just as you would a bicycle lock. After that, position the bottom loop 25 so it is around the shackle U lock 21, just as you did the top loop 24. Then you simply lock the U lock 21, making sure the top loop 24, and the bottom loop 25 are locked securely around the shackle, so they may not be removed without opening the U lock 21.

### Advantages

From the description above a number of advantages of my unicycle lock become evident:
(a) There is currently a commercial need for the product.
(b) It provides a solution to a longstanding problem.
(c) Using bicycle locks allows the frame to be stolen from the unicycle, which is the most valuable part.

Thus the reader will see that my unicycle lock is an improvement over prior art. While my above description contains many specificities, these should not be construed as limitations on the scope of the invention, but rather exemplification of one preferred embodiment thereof. For example the cables could be attached in a different point to the lock. Also the cables could be fitted so that the key unlocked the U lock, as well as freed the cables, rather than threading them through the shackle. The lock could also be used on a bicycle in the event that the user wished it While I use the term U lock and padlock to describe the locking device, any lock, which would perform the job, can be used. This is simply a simplification to express contemplated materials. Accordingly the scope of the invention should be determined not by the embodiment illustrated, but by the appended claims and their legal equivalents.

I claim:

1) A unicycle locking device comprising:
a) a means for locking both a unicycle wheel and a unicycle frame to a fixed structure
b) a device which effectively locks both the unicycle frame and the wheel to a structure to prevent theft such that even if the unicycle was disassembled the unicycle frame and the unicycle wheel would still be impervious to theft

2) A device for locking a unicycle:
a) said device being capable of locking a unicycle frame, and a unicycle wheel to a fixed structure so as to prevent theft of said unicycle frame and wheel even if said unicycle is disassembled
b) said device consisting of a lock of some sort with a means to secure the unicycle
